(19) United States
(12) Patent Application Publication
(10) Pub. No.: US 2012/0286013 A1
(43) Pub. Date: Nov. 15, 2012

(54) OPTICAL FIBER CUTTING DEVICE

(75) Inventor: Fumio AOKI, Oyama-shi (JP)

(73) Assignee: FUJITSU TELECOM NETWORKS LIMITED, Kawasaki-shi (JP)

(21) Appl. No.: 13/447,834

(22) Filed: Apr. 16, 2012

(30) Foreign Application Priority Data
May 11, 2011 (JP) 2011-106250

(51) Int. Cl. G02B 6/25

(52) U.S. Cl. 225/96

(57) ABSTRACT

An optical fiber cutting device includes a fiber holding part holding an optical fiber to be cutting processed, a fiber holding part provided in line with an interval from the fiber holding part and holding a glass core wire part of the optical fiber of which cover is removed, a round blade unit attaching a starting point scratch at a lower surface of a glass core wire of the optical fiber held between the fiber holding parts, and a cutting block pressing an upper surface of the glass core wire corresponding to the starting point scratch from upward, and applying a tensile and a bending stresses to the glass core wire, wherein at least an end face of the cutting block pressing the glass core wire is formed with a rigid material in an R-state along an axis direction of the glass core wire, and the end face is smoothly processed.

### CROSS REFERENCE TO RELATED APPLICATION

This application is based upon and claims the benefit of priority from Japanese Patent Application No. 2011-106250, filed on May 11, 2011, the entire contents of which is incorporated herein by reference.

### BACKGROUND

1. Field

The present application relates to an optical fiber cutting device, and in detail, to an optical fiber cutting device enabling improvement of a cutting quality in a cutting process of an optical fiber being a preprocessing step of fusion splicing of the optical fiber.

2. Description of the Related Art

Extremely large-capacity, extremely long-distance, extremely high-speed, and low cost are highly required for a recent communication apparatus, and an application of a photonic network technology capable of performing signal processing (demultiplexing, branching/inserting, cross connection) without converting optical signals in an optical path into electrical signals has been developed in acceleration to enable the requirements.

Optical parts coupled with each other (optical connector coupling and optical splicing) are mounted on units of an optical circuit configuration (optical module, optical printed circuit board, and so on) used for the photonic network, and the number of optical parts are on the rise.

However, an outside diameter of a connector is large in the optical connector coupling, and an adaptor and fixed parts necessary for the coupling are required, and a wide mounting area is required. Accordingly, in recent years, the optical splicing in which a coupling part can be reduced as disclosed in Japanese Unexamined Patent Application Publication No. 2003-14971 is widely used, and in particular, fusion splicing in which a splicer (dedicated facility) is used, tip portions of two optical fiber core wires (glass core wires) are discharged to be fused in the splicer is widely used. After this fusion splicing, protection of the coupling part is enabled by covering the coupling part with a sleeve, and heating the covered coupling part again in the splicer again to perform thermal shrinkage.

Incidentally, low-loss is required for the fusion splicing of the optical fiber, and therefore, it is necessary to preserve optical fiber cutting quality being a preprocessing step, namely, to process an end face angle (angle θ in (b) of FIG. 2) to be a right-angle as much as possible. Note that a current angle definition is 1.5 degrees or less when the right-angle is set to be “0” (zero) degree.

(a) and (b) of FIG. 2 illustrate schematic configuration charts of a conventional optical fiber cutting device. Hereinafter, the optical fiber cutting device and a conventional optical fiber cutting process using the same are described.

In (a) of FIG. 2, a reference numeral 1 is a fiber holder. At first, an optical fiber 3 to be cutting processed is held by the fiber holder 1, a cover 5 at a tip side of the optical fiber 3 projecting from the fiber holder 1 is removed. The fiber holder 1 is set inside an optical fiber cutting device 7.

The optical fiber cutting device 7 is made up of a stainless-steel base (not-illustrated) formed in a rectangular shape when seen from above and a stainless-steel lid (not-illustrated) attached to be openable/closable to the base via a coupling member such as a hinge, and a holder installation part (not-illustrated) to set the fiber holder 1 is provided at an approximately center of the base. Two fiber holding parts 9, 11 are provided in line at the base and the lid with a predetermined interval from the holder installation part.

The fiber holding parts 9, 11 are made up of pairs of block-state holding members 9a, 9b, 11a, 11b integrally formed at the base side and the lid side of the optical fiber cutting device 7, and a rubber member 13 is attached to a tip portion of each of the holding members 9a, 9b, 11a, 11b. A covered part of the optical fiber 3 extending from the fiber holder 1 set at the holder installation part is disposed on the holding member 9b (rubber member 13) at the holder installation part side, a glass core wire 15 of the optical fiber 3 is disposed on the other holding member 11b (rubber member 13), and the lid is closed, then the optical fiber 3 is held in a linear state between the fiber holding parts 9, 11.

Note that an interval L between the fiber holding parts 9, 11 is set to be 11 mm, and a holding power and a holding width of the optical fiber 3 by each of the fiber holding parts 9, 11 (rubber member 13) are respectively set at approximately 100 g and 4 mm.

Besides, a round blade unit (not-illustrated) loading a round blade (cemented carbide) 17 is slidably provided in an orthogonal direction to the glass core wire 15 (optical fiber 3) on the base at a center between the fiber holding parts 9, 11. The round blade unit is slide-operated in the optical fiber 3 direction after the optical fiber 3 is held between the fiber holding parts 9, 11. Then a starting point scratch 19 of cutting is attached for a depth of 2 μm and a length of 25 μm to 30 μm at a lower surface of the glass core wire 15 by the round blade 17 passing at downward of the glass core wire 15 as illustrated in (a) of FIG. 3.

Further, a cutting block operation stay 23 to which a rubber cutting block 21 in a block state is fixed at a tip lower part is attached at the base of the optical fiber cutting device 7 to be capable of getting up and down toward the base side via a coupling member such as a hinge as same as the lid with correspond to the starting point scratch 19. Note that a cutout in accordance with an outer shape of the cutting block operation stay 23 is provided at the lid, the cutting block operation stay 23 does not work with an opening/closing operation of the lid, and it is possible to operate the cutting block operation stay 23 to get up and down independently. Note that a center position O of the cutting block 21 is set to be ±0.2 mm centering on the starting point scratch 19, and a flatness thereof is set to be “0” (zero) degree as illustrated in (a) of FIG. 3. Besides, a pressure width of the cutting block 21 relative to the glass core wire 15 is set to be 4 mm in an axis direction of the glass core wire 15.

As stated above, the starting point scratch 19 is attached at the lower surface of the glass core wire 15 by the round blade 17, and thereafter, an upper surface of the glass core wire 15 corresponding to the starting point scratch 19 is pressed down by the cutting block 21 while bringing down the cutting block operation stay 23 toward the base side as illustrated in (b) of FIG. 2, to apply a tensile stress and a bending stress to the glass core wire 15. As a result, the starting point scratch 19 grows in orthogonal to an axis direction at a constant stress, and the glass core wire 15 (optical fiber 3) is cut.

However, an end face 21a of the cutting block 21 pressing the glass core wire 15 is not microscopically smooth, but it is actually formed in fine and irregular uneven state as illustrated in (a) of FIG. 3.

Accordingly, there is a case when right-and-left frictional forces at contact portions between the glass core wire 15 and the end face 21a putting the center position O of the cutting block 21 therebetween are different when the upper surface of the optical fiber 3 is pressed down by the cutting block 21. It incurs a difference of tensile stresses F in right and left directions centering on the starting point scratch 19 if the frictional forces are different between right and left. When an end face 21a-1 of the cutting block 21 positioning at a tip side of the glass core wire 15 is wider and has larger frictional force than an end face 21a-2 at an opposite side putting the center position 0 therebetween, a fiber sliding in an arrow A direction occurs at the glass core wire 15 held by the fiber holding part 11 as illustrated in (b) of FIG. 2, a push-in amount P of the cutting block 21 changes as illustrated in (b) of FIG. 3, and the bending stress by the cutting block 21 becomes stronger than a predetermined value when the optical fiber 3 is pressed down by the cutting block 21.

It is impossible to apply well-balanced tensile stress F and bending stress to the glass core wire 15 if the difference occurs in the tensile stress F in the right and left directions centering on the starting point scratch 19 and the bending stress gets stronger. As a result, a problem occurs in which the center positions O of the starting point scratch 19 and the cutting block 21 displace as illustrated in (b) of FIG. 3, and the growth of the starting point scratch 19 is not stable.

### SUMMARY

The present invention is made in consideration of actual circumstances as stated above, and a proposition thereof is to provide an optical fiber cutting device capable of applying a tensile stress and a bending stress to a glass core wire equally to right and left and in a good balance, when an upper surface of the glass core wire corresponding to a starting point scratch is pressed by a cutting block to stably grow the starting point scratch.

To attain the proposition as stated above, an optical fiber cutting device according to an aspect of the present invention includes a fiber holding part holding a covered part of an optical fiber to be cutting processed, a fiber holding part provided in line with a predetermined interval from the fiber holding part and holding a glass core wire part of the optical fiber of which cover is removed, a round blade unit including a round blade attaching a starting point scratch at a lower surface of a glass core wire of the optical fiber held between the fiber holding parts, and a cutting block pressing an upper surface of the glass core wire corresponding to the starting point scratch from upward, and applying a tensile stress and a bending stress to the glass core wire, in which at least an end face of the cutting block pressing the glass core wire is formed with a rigid material in an R-state along an axis direction of the glass core wire, and the end face is smoothly processed.

In the optical fiber cutting device according to another aspect of the present invention, the end face of the cutting block is set to be 50 R or more.

It is possible to apply the tensile stress even in right and left centering on the starting point scratch and the constant bending stress to the upper surface of the glass core wire corresponding to the starting point scratch because the end face of the cutting block is formed in the R-state, and the end face is smoothly processed in the optical fiber cutting device according to an aspect of the present invention.

According to the present invention, there is an advantage in which a cutting quality of the optical fiber improves because the stable growth of the starting point scratch is enabled.

Besides, there is an advantage in which the glass core wire is not broken before it goes along the shape of the end face and the quality is stabilized because the end face of the cutting block is set to be the R-shape of 50 R or more in the optical fiber cutting device according to another aspect of the present invention.

### BRIEF DESCRIPTION OF THE DRAWINGS

FIG. 1 is an expanded front view of a contact part between a cutting block and a glass core wire of an optical fiber cutting device.

FIG. 2 is schematic configuration charts of a conventional optical fiber cutting device.

FIG. 3 is expanded front views of a contact part between a cutting block and a glass core wire of an optical fiber.

### DETAILED DESCRIPTION OF THE EMBODIMENTS

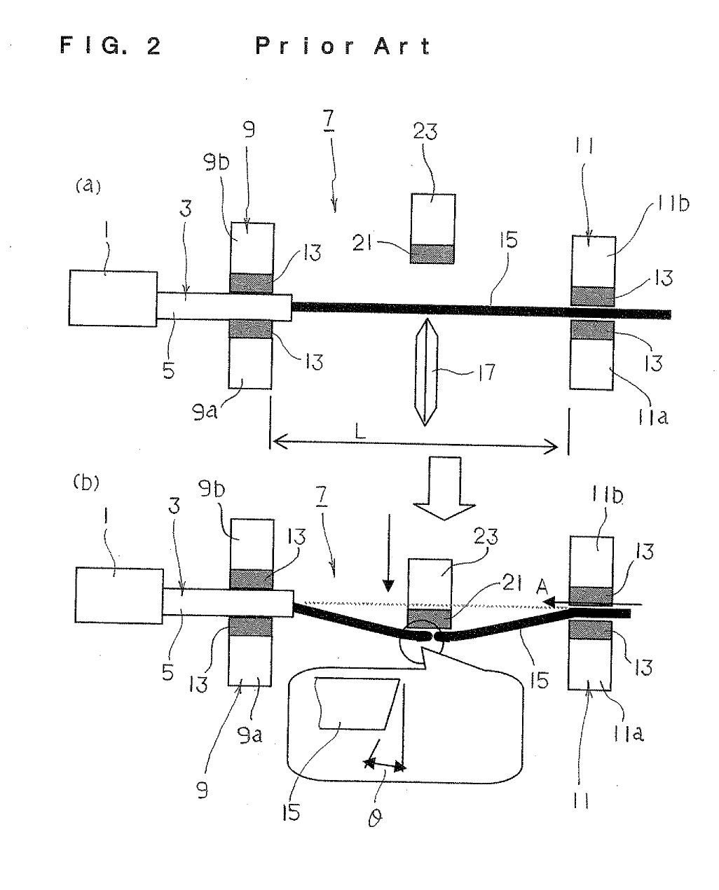

Hereinafter, embodiments of the present invention are described in detail with reference to the drawings. Note that the other configurations except an invented part are the same as a conventional example in FIG. 2, and therefore, the same reference numerals are used to designate the same elements, and redundant descriptions are not given.

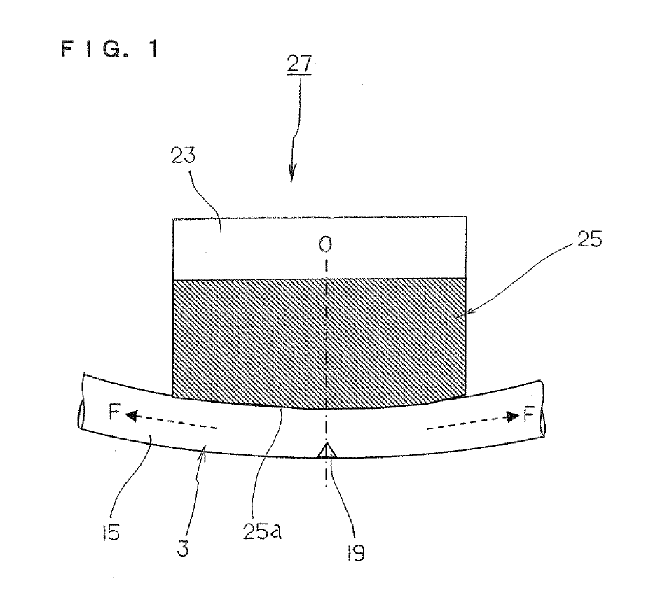

FIG. 1 illustrates an optical fiber cutting device according to an embodiment of the present invention, and in the drawing, a reference numeral 25 is a cutting block fixed at a tip side lower surface of the cutting block operation stay 23, and the cutting block 25 presses an upper surface of the glass core wire 15 corresponding to the starting point scratch 19 to apply a tensile stress and a bending stress to the glass core wire 15 by bringing down the cutting block operation stay 23 toward the base side also in an optical fiber cutting device 27 according to the present embodiment as same as a conventional example in FIG. 2.

Instead of the rubber cutting block 21 in FIG. 2, there are characteristics as stated below in the present embodiment.

(1) A shape of an end face 25a of the cutting block 25 pressing the glass core wire 15 is formed in an R-state in accordance with a shape of the glass core wire 15 deforming in an arc-state according to the pressing down of the cutting block 25, and a radius of curvature thereof is set to be 50 R or more to stabilize the bending stress for the glass core wire 15. It turns out that the R-shape of the end face 25a is required to be 50 R or more at the minimum from an experimental result because there is a possibility in which a quality of the glass core wire 15 deteriorates because it is easy to be broken before the glass core wire 15 comes along the shape of the end face 25a if the “R” is small when the end face 25a of the cutting block 25 is formed in the R-state as stated above.

(2) A whole of the cutting block 25 is formed to be a rigid block-state with a metal material or a resin material, and the end face 25a of the cutting block 25 is smoothly processed to reduce a frictional resistance with the glass core wire 15 to stabilize the tensile stress for the glass core wire 15.

Note that the center position O of the cutting block 25 is set to be ±0.2 mm centering on the starting point scratch 19, and a pressure width of the cutting block 25 (end face 25a) relative to the glass core wire 15 is set to be 4 mm in an axis direction of the glass core wire 15 also in the present embodiment.

The cutting block 25 used for the optical fiber cutting device 27 of the present embodiment is made up as stated above, and at first, the optical fiber 3 is held by the fiber holder 1, then the cover 5 at the tip side of the optical fiber 3 projecting from the fiber holder 1 is removed as same as the conventional example in FIG. 2 to cut the optical fiber 3 by using the optical fiber cutting device 27.

Next, the fiber holder 1 is set at the holder installation part on the base of the optical fiber cutting device 27, a covered part of the optical fiber 3 extending from the fiber holder 1 is disposed on the holding member 9b (rubber member 13), the glass core wire 15 of the optical fiber 3 is disposed on the other holding member 11b (rubber member 13), and the lid is closed, then the optical fiber 3 is held in a linear state between the fiber holding parts 9, 11. Besides, the round blade unit is slide-operated in the optical fiber 3 direction, then the starting point scratch 19 is attached for the depth of 2 μm and the length of 25 μm to 30 μm at the lower surface of the glass core wire 15 as illustrated in FIG. 1 by the round blade 17 passing at downward of the glass core wire 15.

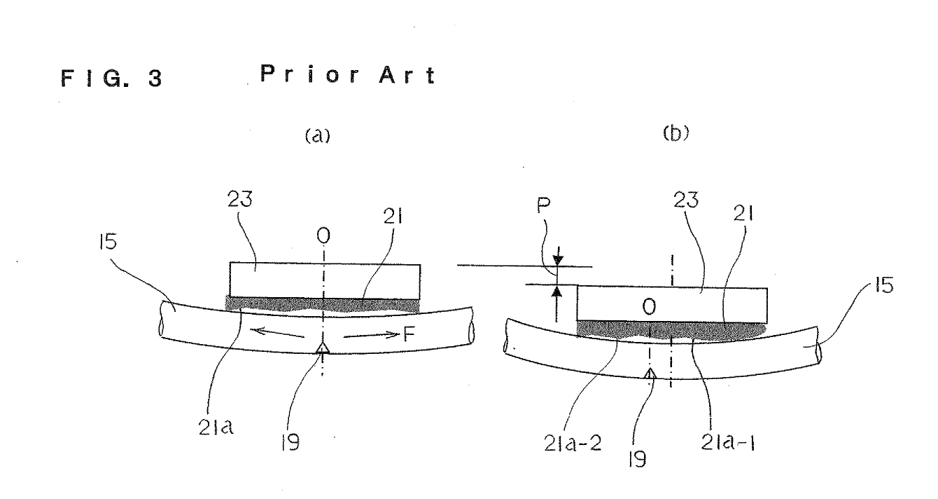

After that, the upper surface of the glass core wire 15 corresponding to the starting point scratch 19 is pressed down by the cutting block 25 while bringing down the cutting block operation stay 23 toward the base side, and thereby, the tensile stress F and the bending stress are applied to the glass core wire 15. However, a constant bending stress is applied to the upper surface of the glass core wire 15 corresponding to the starting point scratch 19 different from the conventional example in FIG. 3, because the end face 25a of the cutting block 25 is set to be the R-shape of 50 R or more according to the shape of the glass core wire 15 deforming in the arc-state, and the end face 25a is smoothly processed as stated above.

Besides, the end face 25a of the cutting block 25 is smoothly processed, and thereby, the frictional resistance between the end face 25a and the glass core wire 15 is drastically reduced. Therefore, the tensile stress F even in right and left directions of the glass core wire 15 centering on the starting point scratch 19 is generated as illustrated in FIG. 1.

It is possible to apply the tensile stress even in right and left centering on the starting point scratch 19 and the constant bending stress at the upper surface of the glass core wire 15 corresponding to the starting point scratch 19, and therefore, the stable growth of the starting point scratch 19 is enabled and the glass core wire 15 is cut by pressing down the cutting block 25.

According to the optical fiber cutting device 27 of the present embodiment, there is an advantage in which the cutting quality of the optical fiber 3 improves compared to the conventional example in FIG. 2 and later.

Besides, there is an advantage in which the glass core wire 15 is not broken before it comes along the shape of the end face 25a and the quality is stabilized because the end face 25a of the cutting block 25 is set to be the R-shape of 50 R or more in the present embodiment.

Note that the whole of the cutting block 25 is formed in the rigid block state with the metal material or the resin material and the end face 25a is smoothly processed in the above-stated embodiment, but it is not necessary to rigidly form the whole of the cutting block, but only the end face part of the cutting block pressing the optical fiber is formed rigidly and smoothly.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An optical fiber cutting device, comprising:
a fiber holding part holding a covered part of an optical fiber to be cutting processed;
a fiber holding part provided in line with a predetermined interval from the fiber holding part and holding a glass core wire part of the optical fiber of which cover is removed;
a round blade unit including a round blade attaching a starting point scratch at a lower surface of a glass core wire of the optical fiber held between the fiber holding parts; and
a cutting block pressing an upper surface of the glass core wire corresponding to the starting point scratch from upward, and applying a tensile stress and a bending stress to the glass core wire,
wherein at least an end face of the cutting block pressing the glass core wire is formed with a rigid material in an R-state along an axis direction of the glass core wire, and the end face is smoothly processed.

2. The optical fiber cutting device according to claim 1,
wherein the end face of the cutting block is set to be 50 R or more.
